(19) United States
(12) Patent Application Publication
(10) Pub. No.: US 2013/0312575 A1
(43) Pub. Date: Nov. 28, 2013

(54) OIL FILTER SERVICE TOOL

(71) Applicant: Charleston Ong, Chatsworth, CA (US)

(72) Inventor: Charleston Ong, Chatsworth, CA (US)

(21) Appl. No.: 13/875,256

(22) Filed: May 1, 2013

Related U.S. Application Data
(60) Provisional application No. 61/687,742, filed on May 2, 2012.

(51) Int. Cl. B25B 27/00; B25B 13/50

(52) U.S. Cl. CPC B25B 27/0042; B25B 13/50
USPC 81/176.1

(57) ABSTRACT

A tool includes a body having at least two ends, an opening in said body to receive a tool, side extensions at each end of the body and one or more side bars extending from each side extension and configured to define one or more slots therebetween. An oil filter tool includes a body having at least two ends and an opening configured to receive a tool. Side extensions at each end of the body connect to the body through a bend. One or more side bars extend from each side extension and are configured to define one or more slots therebetween.

### CROSS REFERENCE TO RELATED APPLICATIONS

This application claims the benefit of US provisional application No. 61/687,742 filed on May 2, 2012, the entirety of which is hereby incorporated by reference.

### BACKGROUND

An oil filter's role in an automotive engine is to remove contaminants from engine oil. As a result, frequent replacement of the filter helps ensure the engine's longevity. To conserve resources in recent years, modern automobile oil filters allow for the changing only of the filtering element rather than changing the entire filter assembly (including the housing and filtering element). The typical procedure for changing the filtering element usually involves first uncoupling the oil filter housing from the engine and discarding the old filtering element. For installation, the new filter element is inserted in the filter housing, and the whole assembly is coupled back with the engine.

Referring to FIG. 1, an end cap 1 of an oil filter is usually provided with a multi-sided shape 3 which conforms to the multi-sided shape of a traditional oil filter tool 5. By rotating the traditional oil filter tool 5, the oil filter can be therefore rotated and removed from the engine. FIG. 1 shows the end cap 1 opposing the traditional oil filter tool 5.

FIG. 2A shows the traditional oil filter tool 5 placed over the corresponding shape of the end cap 1. A not uncommon drawback of this attachment method is that under circumstances, whether because the traditional oil filter tool 5 is not precisely manufactured or because of deformation of the shape of the traditional oil filter tool 5, the oil end cap 1 may not fit within the traditional oil filter tool 5, and slippage may occur. The slippage can cause wear and damage on the mating surfaces, and it may become impossible to remove the filter housing. Another common complaint of this traditional oil filter tool 5 is that it can become wedged into the end cap 1, and become very difficult to separate from the end cap without damage to the filter housing 1. FIG. 2B shows the traditional oil filter tool 5 applied to the end cap 1 of an oil filter.

### SUMMARY

An aspect of the technology described herein relates to a tool that includes a body having at least two ends, an opening in the body to receive a tool, and side extensions at each end of the body. One or more side bars extend from each side extension and are configured to define one or more slots therebetween.

Another aspect of the technology described herein relates to an oil filter tool that includes a body having at least two ends and an opening configured to receive a tool. Side extensions at each end of the body connect to the body through a bend. One or more side bars extend from each side extension and are configured to define one or more slots therebetween.

### BRIEF DESCRIPTION OF THE DRAWINGS

FIG. 1 is a perspective view of the end cap opposing the traditional oil filter tool.

FIG. 2A is a perspective view of the traditional oil filter tool placed over the corresponding shape of the end cap.

FIG. 2B is a perspective view the traditional oil filter tool as it is applied to the end cap of an oil filter.

FIG. 3 is a perspective view of the end cap.

FIG. 4 is a perspective view of an oil filter service tool.

FIG. 5 is a perspective view of the oil filter service tool with its slots disposed over the axial protruding winglets of an end cap.

FIG. 6 is a perspective view of FIG. 5 from a different perspective.

FIG. 7 is perspective view of the oil filter service tool.

FIG. 8 is a perspective view of the oil filter service tool.

FIG. 9 is a perspective view of one embodiment of the oil filter service tool with a ratchet handle and extension.

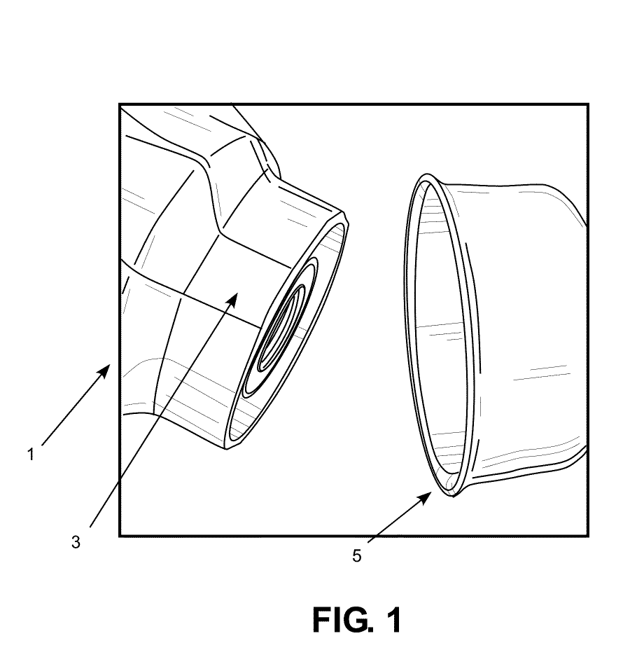

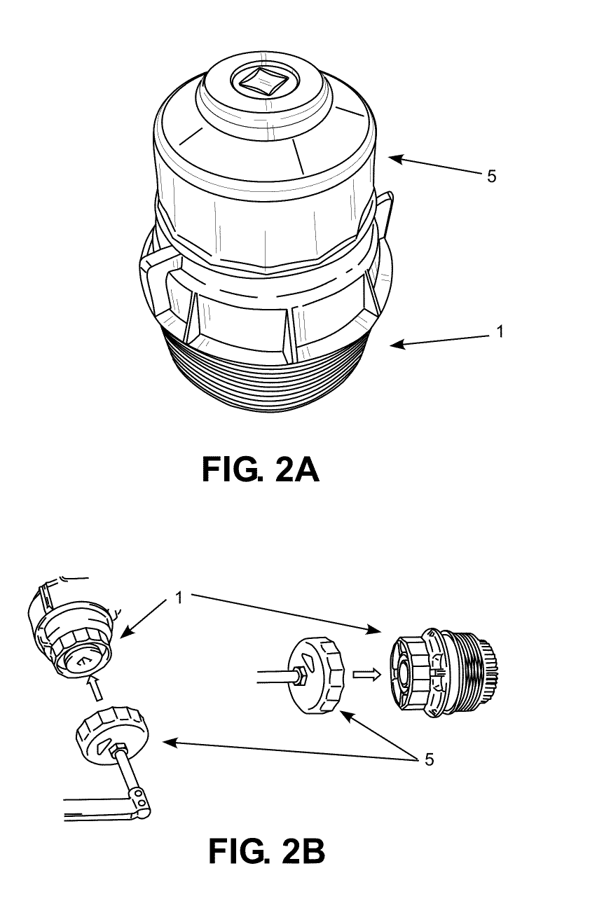

### DETAILED DESCRIPTION

The present technology relates to an apparatus, system, and method for making the same related to an oil filter service tool.

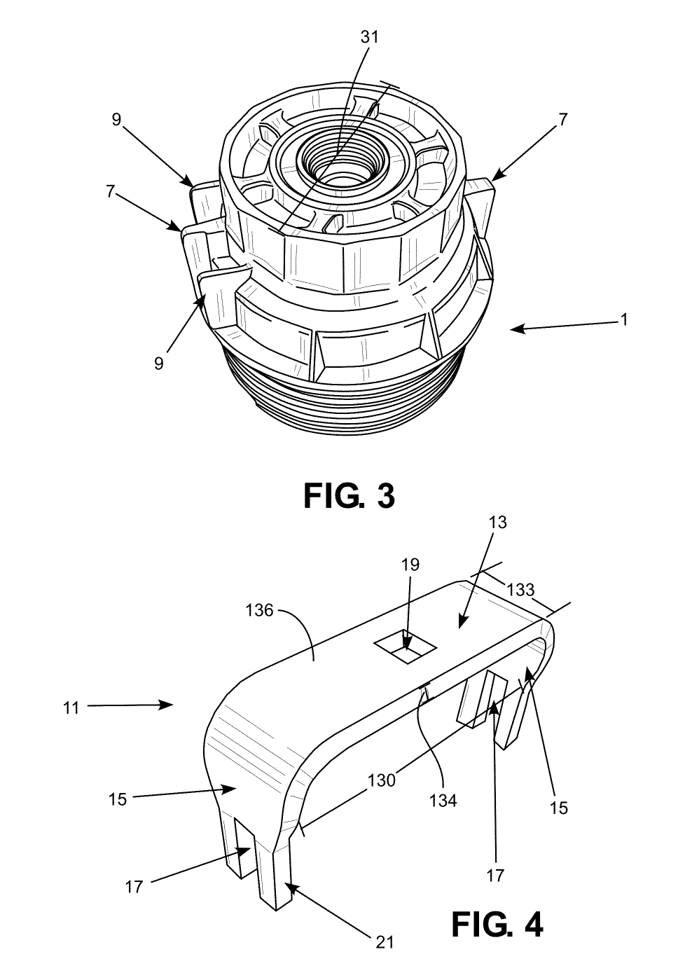

FIG. 3 shows an end cap 1 having a diameter or length 31, winglets 7 and optional auxiliary winglets 9.

FIG. 4 is a view of an oil filter service tool 11, which can include a body 13, side extensions 15 at each end of the body 13 and slots 17 at the ends of each side extension 15. The body 13 can have an opening 19 into which a tool such as that of a ratchet wrench, ratchet handle, shaft, extension, screw driver or other tool can be inserted to provide torque to rotate the oil filter service tool 11.

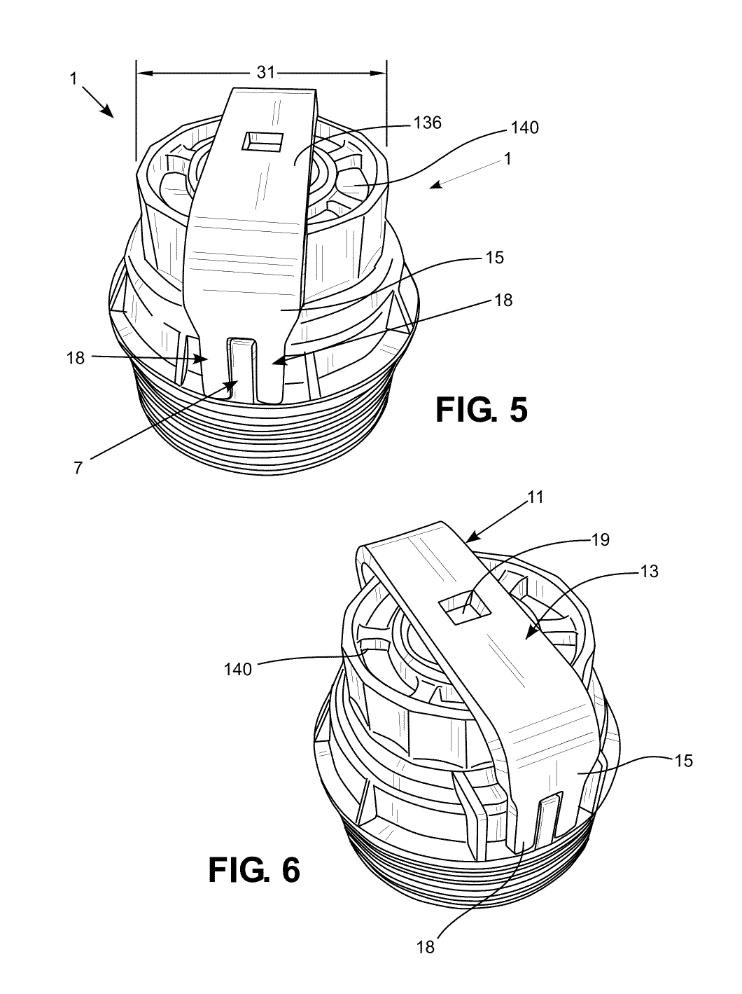

In some embodiments, the body 13 is configured to have at least a first side (length) 132 and a second side (width) 133. In some embodiments, the length 132 is greater than the width 133 as shown in FIG. 4. In some embodiments, the length 132 preferably is such that the oil filter service tool 11 fits over a diameter or length 31 of the end cap 3 as shown in FIGS. 5 and 6. In some embodiments, the body 13 is narrow, with a width 133 preferably less than a diameter or length 31 of the end cap 1. In some embodiments, the width 133 may be equal or greater than the diameter or length 31 of the end cap 1. In some embodiments, the width 133 can be such that at least a portion 140 of the end cap 1 remains exposed upon engagement of the filter tool 11 with the end cap 1. In some embodiments, the body 13 has a shape independent of the shape of the end cap 1.

In some embodiments, the body 13 of the oil filter service tool 11 may have a substantially even top surface 136. In some embodiments, the body 13 of the oil filter service tool 11 may have a substantially even bottom surface 138. In some embodiments, the body 13 has a substantially even thickness. In some embodiments, the side extensions 15 at each end of the body 13 and slots 17 at the ends of each side extension 15 may also have substantially even top and/or bottom surfaces and/or have a substantially even thickness. In some embodiments, the opening 19 may be inset into the body 13. The opening 19 is preferably shaped to receive a ratchet interface. Accordingly, the opening 19 may be any shape, based on the ratchet used. In some embodiments, the opening 19 is preferably square-shaped. In some embodiments, the opening 19 is preferably rectangular-shaped. In some embodiments, the opening 19 extends through the entire thickness 134 of the body 13. In some embodiments, the opening 19 extends only partially through the thickness 134.

In some embodiments, the side extensions 15 at each end of the body 13 and slots 17 at the ends of each side extension 15 are a single piece of metal. In some embodiments, the tool can be inexpensively manufactured with high grade steel and with a thickness 134 that is optimized for strength. The thickness 134 may be uniform across the body 13 in some embodiments. In some embodiments, the side extensions 15 and side bars 18 may also have a uniform thickness. In some embodiments, oil filter service tool can be formed by creating a bend with a precision hydraulic press, for example, that provides a larger radius that enhances strength. The slots 17 may be designed to fit with substantial precision over the axial protruding winglets 7. Other techniques for forming the oil filter service tool 11 are also contemplated.

FIG. 5 shows an embodiment of the oil filter service tool 11 with its slots 17 disposed over the axial protruding winglets 7 of an end cap 1. It is noted that the slots 17 are configured so that the two side bars 18 that form the slot extend substantially down the length of the axial protruding winglets 7 to provide a secure fit.

FIG. 6 shows a similar assembly from a different perspective, with oil filter service tool 11 with ratchet hole 19 engaged on the end cap 1 such that at least a portion 140 of the end cap 1 remains exposed.

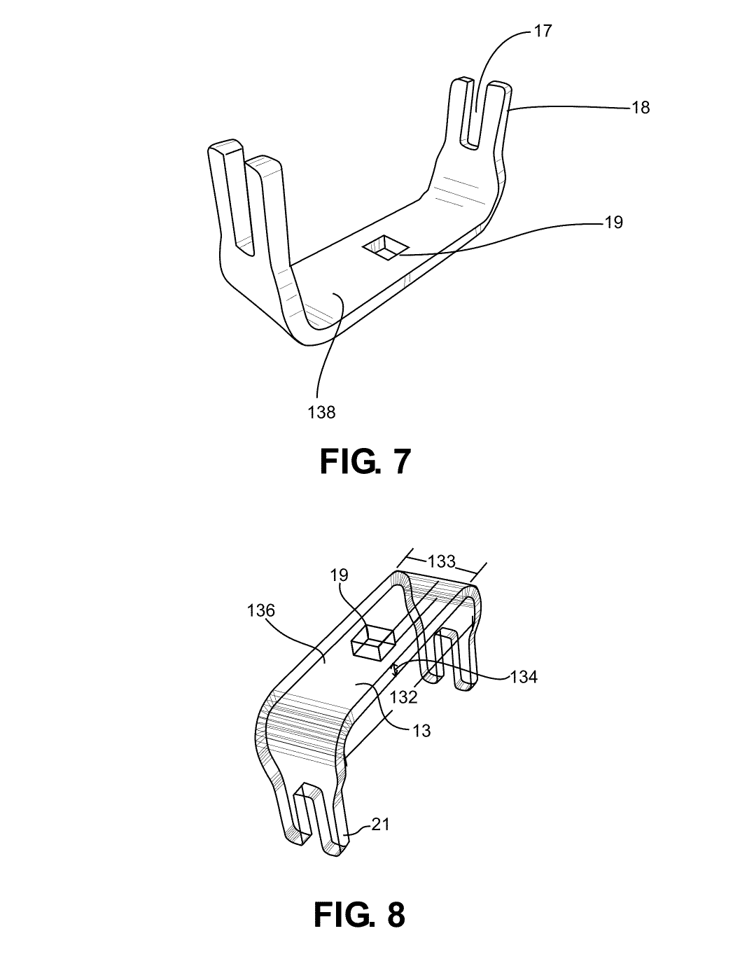

FIG. 7 shows another perspective of an underside of the oil filter service tool 11 with opening extending through the thickness of the oil filter service tool 11 and having a bottom surface 138, which in some embodiments may be substantially even.

FIG. 8 shows another perspective of the oil filter service tool 11. In some embodiments, the side extensions 15 may be tapered inwardly or outwardly from the body 13 toward the end of the two extremities of the end cap 1 as shown in FIG. 8. This feature may allow the side peripheries 21 to extend from the end cap 1 so as to avoid abutting another part of the automobile to impede or prevent the end cap's rotation. Alternatively, the side peripheries 21 may be beveled to allow the desired clearance for rotation.

In some embodiments, the slots 17 between the side bars 15 may be sufficiently sized and shaped to receive one or more winglets 7 for engaging the tool with the end cap 1 to reduce or prevent slipping when rotated. The shape of each of the side bars 15 may be the same or different with respect to one another. Each of the slots between the side bars 15 may be the same width or shape or different with respect to one another, and typically depend on the winglet 7 which the slot receives. In the engaged position, the oil filter tool can provide grip and reduce or prevent slippage when the tool is rotated. In some embodiments, the oil filter service tool 11 is configured to slidably engage and disengage from the winglets 7.

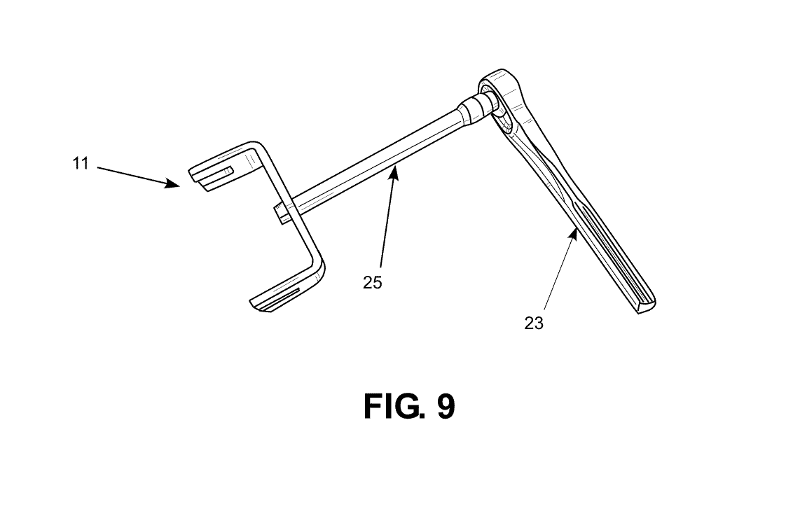

FIG. 9 illustrates an embodiment of the oil filter service tool 11 with a ratchet handle 23 and extension 25.

It is to be understood that the foregoing is for illustrative purposes only. There may be other shapes or embodiments which the oil filter service tool may take that will provide the same or similar features of efficiency of use, ease of use, economy of manufacture and secure grasping of the end cap. For example, the side extensions 15 may be provided with additional slots that can fit over the auxiliary protruding winglets 9. This is contemplated by this disclosure.

While certain features have been described herein, many other features are contemplated and fall within the scope of the disclosure.

All elements, parts and steps described herein are preferably included. It is to be understood that any of these elements, parts and steps may be replaced by other elements, parts and steps or deleted altogether as will be obvious to those skilled in the art.

What is claimed is:

1. A service tool, comprising:
a body having at least two ends;
an opening in said body to receive a tool;
side extensions at each end of the body; and
one or more side bars extending from each side extension and configured to define one or more slots therebetween.

2. The tool of claim 1, wherein the body is a narrow body.

3. The tool of claim 1, wherein the body has a length and a width.

4. The tool of claim 3, wherein the length and width are different dimensions.

5. The tool of claim 4, wherein the length is greater than the width.

6. The tool of claim 3, wherein the length is sufficient to fit over a diameter of an end cap.

7. The tool of claim 3, wherein the width is less than a diameter of an end cap.

8. The tool of claim 1, wherein the body has a shape independent of the shape of an end cap.

9. The tool of claim 1, wherein the body has a substantially even top and bottom surface.

10. The tool of claim 1, wherein the body, the side extensions and the one or more side bars have a substantially even thickness.

11. The tool of claim 1, wherein the opening is inset into the body and extends through an entire thickness of the body.

12. The tool of claim 1, wherein the side bars are tapered.

13. The tool of claim 1, wherein the side bars are beveled.

14. The tool of claim 1, further configured to slidably engage and disengage from one or more winglets on an end cap.

15. The tool of claim 1, wherein the body, the side extensions and the one or more side bars comprise a single piece of metal.

16. An oil filter tool, comprising:
a body having at least two ends and an opening configured to receive a tool;
side extensions at each end of the body, wherein the side extensions connect to the body through a bend; and
one or more side bars extending from each side extension and configured to define one or more slots therebetween.

17. The oil filter tool of claim 16, wherein the body has a length and width of different dimensions.

18. The oil filter tool of claim 16, wherein the one or more slots are configured to receive a corresponding winglet arranged on an end cap to secure the oil filter tool with the end cap.

19. The oil filter tool of claim 16, wherein the side bars are tapered inward.

20. The oil filter tool of claim 16, wherein the bend is configured to enhance strength.
